(19) United States
(12) Patent Application Publication
(10) Pub. No.: US 2003/0030597 A1
(43) Pub. Date: Feb. 13, 2003

(54) Virtual display apparatus for mobile activities

(76) Inventor: Richard Edwin Geist, Grosse Ile, MI (US)

Correspondence Address: Richard Geist, 28310 Elbamar Drive, Grosse Ile, MI, 48138, US

(21) Appl. No.: 10/216,958

(22) Filed: Aug. 12, 2002

Related U.S. Application Data
(60) Provisional application No. 60/311,926, filed on Aug. 13, 2001.
(60) Provisional application No. 60/311,927, filed on Aug. 13, 2001.
(60) Provisional application No. 60/311,928, filed on Aug. 13, 2001.
(60) Provisional application No. 60/311,929, filed on Aug. 13, 2001.

(51) Int. Cl. G09G 5/00

(52) U.S. Cl. 345/8

(57) ABSTRACT

The present invention teaches a method of constructing head-mounted virtual display apparatuses for mobile activities based on a non-cross-cavity optical configuration, which simultaneously provides the user with “look toward” access to an inset virtual image and an unobstructed forward field of view of at least 35 degrees. In one embodiment, a pair of light deflecting elements and associated adjustment means project a light path from the normal peripheral field of view towards the eye without geometric distortion of the virtual image associated image plane tilt.

### CROSS REFERENCE TO RELATED APPLICATIONS

This application claims the benefit of U.S. Provisional Application No. 60/311,926, filed Aug. 13, 2001 and entitled “Head-Mounted Virtual Display Apparatus for Mobile Activities”; U.S. Provisional Application No. 60/311,927, filed Aug. 13, 2001 and entitled “Virtual Display Apparatus for Mobile Activities with an Adjustable Near-Eye Light Deflecting Element”; U.S. Provisional Application No. 60/311,928, filed Aug. 13, 2001 and entitled “Adjustable Boom-Style Virtual Display Apparatus”; and U.S. Provisional Application No. 60/311,929, filed Aug. 13, 2001 and entitled “Mobile Activities Virtual Display Apparatus”.

### BACKGROUND OF INVENTION

a) Field of the Invention

The present invention relates to a virtual display apparatus (VDA) with a near-eye optic disposed for light deflection, for presenting to the eye a magnified virtual image of a miniature display when the viewer's gaze is directed towards the periphery. More particularly, the present invention relates to a head-mounted virtual display apparatus where a grouping of one, two or three light deflecting elements (LDEs), at least one of which is moveable and finely controllable, combine to redirect the light path from a miniature display towards the eye to provide “look toward” access to an inset virtual image, while simultaneously providing unobstructed forward vision.

b) Description of the Prior Art

The head-mounted display (HMD) field has evolved on a number of fronts over the past 20 years. The earliest development by the military focused on wide field of view (FOV), see-through helmet-mounted displays for aircraft guidance and weapon aiming applications, in which the virtual image overlies the ambient environment. Since then development has included lightweight monocular HMDs for workplace wearable computer systems, binocular HMDs for full-immersion viewing of video and virtual reality applications, and various types of see-through displays for augmented reality applications.

Monocular HMDs are designed to provide access to electronic information while obscuring only a portion of the forward and peripheral fields of view. A typical monocular HMD approach places the display and optics directly in front of one eye, such that the forward FOV of that eye is partially or fully occluded and a portion of the peripheral FOVs of one or both eyes is partially occluded. The most common example of this type of monocular HMD is a boom style HMD, in which a viewable element (and often the display) is positioned in front of the face at the end of a cantilever arm. The main advantages of a boom style HMD include its relative simplicity (i.e., its one size fits all nature and minimal number of adjustments) and its construction flexibility, in that it can be added to a pair of spectacles or any head-borne structure, or can be constructed as a stand-alone headset. The disadvantages of a boom style HMD include a physical boundary that extends a distance from the face, occlusion of a portion of the forward FOV, and its suitability primarily for stationary activities due to vibration of the cantilever arm during user motion.

A second monocular END approach integrates the virtual display elements, in part or in full, into a pair of spectacles, with the aim of not significantly altering its form or weight. This approach allows the display and optics to be kept closer to the face, thus making it possible to limit the occluded FOV to one eye and, in some cases, to only a small portion of the peripheral FOV. The compact nature of a glasses-mounted display (GMD), however, generally requires a folding of the optical train, which increases the complexity of the construction.

In general, monocular HMDs can be categorized according to the whether the optical train (or optical configuration) is an on- or off-axis configuration. In an on-axis optical configuration, the optical axis of each powered optical element is coincident with the optical or illumination path (with the exception of unpowered, LDEs used to “turn corners”). No optics are “tilted” with respect to the optical path. Off-axis optical configurations, on the other hand, generally include at least one powered optical element whose optical axis is tilted with respect to the optical path. Offs axis optical configurations allow more compact constructions but suffer from higher levels of aberrations.

Monocular HMDs can be further categorized according to the nature of the magnification system, of which there are two basic types: simple and compound magnification systems. A simple magnification system (or simple magnifier) is a single stage, non-pupil forming magnification system (i.e., a magnification system that does not form a real exit pupil), which is composed of either a positive refractive or reflective, or multiple adjacent refractive elements with no spacing between them. A compound magnification system, on the other hand, is a pupil forming magnification system composed of two or more distinct stages. In a compound magnification system, the stage closest to the object is termed the objective or relay, while the stage viewed by the eye is termed the eyepiece or ocular. In a two stage compound magnification system, the objective forms an “intermediate” image (either real or virtual) that is the “object” projected virtually by the eyepiece. For the purposes of this invention, a third type of magnification system termed a compound eyepiece—is defined as one in which multiple refractive and reflective elements (including the eyepiece) are in close proximity to one another with spacing between at least two of the elements. A compound eyepiece is effectively a single stage (pupil-forming) magnification system, which is typically located closer to the eye than it is to the display. Put another way, the distance between the display and the first magnifying element (or the “objective”) of the system is typically greater than the distance between the first magnifying element and the eyepiece. For a compound magnification system the converse typically holds. For example, consider an HMD with a display located above the eye and a compound eyepiece located below the eye, which is formed from a single block of material and includes three magnifying surfaces: a refractive entrance surface, a reflective intermediate surface and a refractive exit surface. This device includes multiple spaced magnifing elements (so it cannot be categorized as a simple magnification system) and the distance between the entrance and exit surfaces (or the “objective” and “eyepiece” for comparison purposes) is less than the distance between the display and the “objective”. Thus, the magnifying power is not distributed throughout the optical train like a two stage, compound magnification system.

The design of an HMD involves two generally conflicting aims: (i) achieving a high quality, computer monitor sized virtual image (i.e., a virtual image with a diagonal dimension of at least 10 inches and preferably 15 inches or greater) at a desired apparent image distance (such as a workstation distance of about 24 inches) and (ii) the desire for a compact, lightweight format. One method of balancing these aims is through the use of lightweight, reflective or light deflecting elements (LDEs), such as a mirror constructed from a plastic substrate and a reflective film. Through the use of higher optical powers or by increasing the optical path length, powered and unpowered LDEs may be used to increase magnification and to distribute the weight of the optics more evenly about the head.

A monocular HMD for mobile activities must present a stationary virtual image to the eye during user motion. This requires that the support frame be stably secured to the head and that the display and optics be stably secured to the frame. Taking user comfort into account, the former requirement is best satisfied by a support frame in contact with both ears and the bridge of the nose; while the latter requirement negates the use of a relatively long, thin cantilever arm as the support structure for attaching the eyepiece to the frame, since this type of structure is susceptible to vibration during user motion. For safety and performance reasons, another key requirement for a mobile activity HMD is unobstructed forward vision.

For the purposes of the present invention, the head-mounted display field is further categorized according to: (i) whether the device is suitable for mobile activities; (ii) the optical configuration obstructs normal forward vision; and (iii) whether the optical configuration is a cross-cavity optical configuration (CCOC) or a non-cross-cavity configuration (non-CCOC).

As defined by Geist in disclosure Ser. No. 60/311,928, incorporated herein by reference in its entirety, a cross-cavity optical configuration is an optical configuration in which at least two elements of the optical train lie on opposite sides of the ocular cavity, such that when the system is properly aligned, the light path crosses directly in front of a forward gazing eye. In addition, a mobile activities HMD is defined by Geist as an HMD with an unobstructed forward line-of-sight of at least 35° and an unshakeable head-borne mounting (i.e., a head-mounted support in contact with the bridge of the nose and at least two additional areas of the side(s) and/or back of the head, such that the resulting three contact areas provide a stable, unshakeable platform for the optical train). Suitable mobile activities head-mounted supports include, but are not limited to, conventional eyewear, goggles held in place with a strap or headband, and a headset style head-borne support in contact with an ear and/or the side of the head, in addition to the bridge of the nose.

A key factor in compact HMD designs is the level of optical aberrations or image degrading factors. For the purposes of this invention, image degrading factors are divided into two general categories.

The first category of image degrading factors includes all types of geometrical distortions, which are inherent in most off-axis optical configurations. In general, geometric distortion represents the inability of the system to correctly map the shape of the object into image space (i.e., geometrical distortion represent mapping errors). In the case of conventional, symmetric distortion (commonly referred to as barrel and pincushion distortion), the image appears warped (or bowed) inwards or outwards. In the case of keystone distortion, a difference in path length from one area of the object to another results in a trapezoidal shaped image for a nominally rectangular object. Keystone distortion arises in off-axis projection systems and in optical systems when the optical axis of a powered optic is not perpendicular to the plane of the object (e.g., when the magnifying stage is tilted with respect to the display or vice versa). Keystone distortion is inherent in most off-axis HMD optical configurations, as are some higher-order, asymmetric types of geometric distortion. A further source of geometrical distortion—in the form of tilting of the image plane-arises in optical systems with tilted surfaces. Image plane tilt commonly results in a parallelogram shaped image for a nominally rectangular object.

The purely geometric nature of these types of optical aberrations allow them to be quantified and the display images predistorted (i.e., compensated electronically or computationally) in such a way as to cancel out the geometric distortion generated by the optics. Presently a number of companies offer image warping chips for this purpose. For example, the LEHK-3C display controller from Liesegang Electronics is capable of predistorting images to correct for the aforementioned geometrical distortions. When applicable, this approach is particularly useful in HMD constructions since it allows the number of elements in the optical train to be kept to a minimum.

In practice, however, unless the distortion is of a fixed, unchanging nature, some means of adjustment is generally required to minimize or eliminate sources of geometric distortion in a multi-user HMD.

The second category of image degrading factors are those that cause a decrease in image sharpness or quality and include chromatic aberrations, astigmatism, coma and spherical aberrations, among others. This category of image degrading factors must be addressed through the use standard optical design techniques (which typically involves using multiple optical elements, surfaces and/or coatings to achieve a desired set of optical parameters, such as image magnification, exit pupil size, exit pupil location, etc.) while maintaining a level of image sharpness acceptable to the eye. For example, the off-axis optical configurations of most wide FOV, see-through HMDs suffer from a higher degree of coma, astigmatism and higher-order asymmetric distortion than a comparable on-axis configuration. The predominate image-degrading aberration of an off-axis optical configuration is third-order astigmatism, which, in the case of wide field of view HMDs, is typically minimized through the use of a toroidal reflective eyepiece. Geist disclosed an HMD suitable for mobile activities based on a CCOC (FIG. 1) in “Virtual Display Apparatus with a Near-Eye Light Deflecting Element” (Ser. No. 09/849,872). Other prior art based on a CCOC include Spitzer (U.S. Pat. No. 5,886,822), Heacock et. al. (U.S. Pat. No. 5,539,422), Furness et. al. (U.S. Pat. No. 5,162,828), and Bettinger's pending improvement on U.S. Pat. No. 4,806,011. Many of the embodiments of these inventions can be classified as mobile activities HMD. However, none of these inventions provide the adjustment means necessary to orthogonally align the virtual image plane with the eye of each user in the case of a non-cross-cavity optical configuration (non-CCOC).

A number of boom-style or cantilever arm type HMDs have appeared in the prior art that may be classified as mobile activities HMDs (such as U.S. Pat. No. 4,869,575 disclosed by Kubik). However, the common disadvantage of this type of HMD is the inability to moveably and independently adjust the near-eye light deflecting element or near-eye optic.

Kutz (WO 98/29775) discloses a mobile activities HMD based on a non-CCOC, wherein a pair of miniature displays and optical means are positioned above eye level. However, no adjustment means are provided to establish orthogonality for each user.

### SUMMARY OF THE INVENTION

In order to overcome the above-mentioned deficiencies and problems in the prior art, this invention teaches a method of constructing a mobile activities HMD based on a non-cross-cavity optical configuration, in which near-eye optic is located in the normal peripheral field of view.

Virtual image orientation is a key factor in user comfort and extended use of an HMD. Orienting a real image, such as a written document or computer screen, at a comfortable viewing angle is an every day activity. Quantitatively, the orientation of the virtual image plane is defined in terms of angles α and β (FIG. 2). Three groups of α and β values are pertinent to the present discussion. The first group corresponds to the case when the image plane is normal to the optical axis between the eye and the image plane, i.e., when α=β=90°. This corresponds to the image orientation when viewing an object at optical infinity and, for the purposes of this invention, is termed two-dimensional orthogonality. The second group of values of interest is when β differs from 90° and corresponds to the undesirable effect of image plane tilt. The third case of values is an acceptable deviation from two-dimensional orthogonality corresponding to a slight forward or backwards tilting of the image plane and is defined herein as one-dimensional orthogonality: β=90° and 120°≧α≧60°. Briefly summarizing, it is not generally acceptable to a viewer for β to deviate from 90°, but some deviation from two-dimensional orthogonality may be acceptable (to many users) and may be preferable for certain user specific tasks.

It follows that a mobile activities HMD satisfying two-dimensional orthogonality (or one-dimensional orthogonality with α variable) generally requires independent or simultaneous articulation of two adjacent LDEs, to accommodate the differing pupil positions of each user.

1. Objects of the Invention

A general object of this invention is to provide a virtual display apparatus, suitable for temporary or permanent attachment to a head-mounted apparatus (or support), that does not obstruct forward vision and thus is suitable for mobile activities.

Another general object of this invention is to provide a virtual display apparatus for mobile activities of modular construction, with individual and detachable assemblies for the illumination source and optics.

2. Features of the Invention

In keeping with these objects and others that will become apparent hereinafter, one feature of the invention resides, briefly stated, in a virtual display apparatus in which the real image source is viewed indirectly via a near-eye light deflecting means.

A further feature of the invention resides in a virtual display apparatus with an inset image located anywhere in the normal peripheral FOV, such that normal forward vision (as defined herein) is unobstructed.

A still further feature of the invention resides in the use of moveable connections to adjust the orientation of one or more light deflecting elements in order to accommodate the differing interpupillary distance and vertical pupil location of each user and to eliminate or minimize geometric distortion due to tilting of the virtual image plane.

A still further feature of the present invention resides in a selection of light deflecting means for the near-eye optic, including spherical and aspherical mirrors, and partially transparent mirrors.

A still further feature of the present invention resides in the use of distinct assemblies for the image source, near-eye optic, folding optics and additional optics (corresponding to a modular construction capability).

A still further feature of the present invention resides in freedom to place elements of the virtual display apparatus completely or partially within the boundary of the support frame of a head-mounted apparatus or completely outside the boundary of the support frame of a head-mounted apparatus.

As used herein, the terms magnification or magnifying are sometimes used to denote both magnification and demagnification. Accordingly, the terms magnification and magnifying encompass, and are sometimes used herein to denote, magnification of greater than one, demagnification of less than one and unit magnification. In addition, the terms powered and unpowered are used herein to refer to optical elements with non-zero and zero diopter values, respectively.

As used herein, conventional eyewear refers to all varieties of prescription and non-prescription eyeglasses (or spectacles) including, but not limited to, sunglasses, computer glasses and safety glasses. Common features of conventional eyewear include a structural support frame that uses both ears and the bridge of the nose for support, weight bearing and stabilization during user activity; and individual lenses covering each eye, which are attached and connected to the support frame. The support frame of conventional eyewear is typically comprised of three principal elements: two temples or earpieces, which rest atop the ears and extend from behind the ears to near the temple, and a lens holder, which extends from temple to temple and rests atop the bride of the nose via an integral or removably attached nosepiece or bridge support. The temples of conventional eyewear are typically, but not exclusively, movably attached to the lens holder. Integral or single-piece support frames are also known. In addition, the lens holder of conventional eyewear typically, but not exclusively, includes means for detachably mounting the lenses to the lens holder. Lens/lens holder combinations with the lenses rigidly, but not permanently, affixed to the lens holder are also known, as are integral lens/lens holders.

For the purposes of this invention, the term light deflection means refers to any type of optical element with substantial reflective characteristics. This includes partially and fully reflective mirrors, optical elements based on total internal reflection (such as a non-dispersing, reflecting prism), and holographic optical elements transcribed with reflective properties. The reflective properties of a mirror depend on the nature of the reflective coating applied to the supporting substrate (which may be glass, plastic or other appropriate material). The reflective layer is typically created by depositing a metal coating (such as aluminum or silver) or affixing a reflective polymer film using an adhesive or other standard bonding method. The substrate's surface contour may take any non-planar or curving form (e.g., a spherical, toroidal or parabolic surface contour).

Image placement refers to changing the apparent distance from the eye of a focused observable virtual image. Image placement plays a key role in minimizing eye (muscle) fatigue and possible user discomfort during extended periods of HMD use. The standard approach to reducing eye fatigue is to place the virtual (or apparent) image at an apparent (or perceived) distance comparable to that of the primary objects in the user's forward FOV in order to minimize accommodation when the eye switches back and forth between the virtual image and the primary objects. For example, rather than having the virtual image at a standard reading distance of 250 mm, a person working at a computer may wish to perceive the image at a workstation distance of 600 mm to minimize the need for accommodation by the eye when switching between the real image of the computer screen and the inset virtual image of the present invention. This may be accomplished by either fixing the apparent distance based on the primary task of the wearer or by including an adjustment to allow the user to change the apparent distance according to the task at hand.

Furthermore, focusing or focus control refers to the placement of a sharp, resolute virtual image (i.e., an image in which aberrations are sufficiently low to prevent blurring of pixel detail) within the region defined by a user's near point (i.e., the closest a person can clearly view an object) and far point (i.e., the farthest they can clearly view an object).

It will be understood by one of ordinary skill in the art that when an articulating means is employed to move the near-eye optic (and any underlying support elements) outside the normal peripheral FOV, latching mechanisms may be used to temporarily secure the near-eye optic in its functional and non-functional positions.

It will be further understood by one of ordinary skill in the art that standard techniques for minimizing glare and washout from external and internal sources of illumination, such as anti-reflective coatings, opaque coatings, opaque baffling, opaque housings, etc., may be required.

It will be still further understood by one of ordinary skill in the art that sensors, transducers, and/or microprocessors may be added to the virtual display apparatus of the present invention by their attachment, incorporation, integration and/or embedding into the support means, a head-mounted support, the transparency means of a head-mounted support, elements of one or more assemblies, or a combination of these components anywhere in the proximity of the head.

It will be still further understood by one of ordinary skill in the art that audio/visual accessories, such as an audio speaker, a microphone, a camera, etc., may be added to the virtual display apparatus of the present invention by their attachment, incorporation, integration and/or embedding into the support means, a head-mounted support, the transparency means of a head-mounted support, elements of one or more assemblies, or a combination of these components anywhere in the proximity of the head.

It will be still further understood by one of ordinary skill in the art that a supplemental means of securing the apparatus to the head—such as an adjustable strap or elastic headband—may be used to help prevent against slippage and/or dislodging of the head-mounted support during user motion and activity.

These and other modifications and applications of the present invention will become apparent to those skilled in the art in light of the following description of embodiments of the invention. However, it is to be understood that the present disclosure of these mechanisms are for purposes of illustrations only and are not to be construed as a limitation of the present invention. All such modifications that do not depart from the spirit of the invention are intended to be included within the scope of the claims and specifications stated within.

### BRIEF DESCRIPTION OF DRAWINGS

The present invention is further described with reference to the accompanying drawings, in which:

FIG. 1 is a prior art example of a glasses-mounted virtual display based on a cross-cavity optical configuration.

FIG. 2 illustrates the angular orientation of the virtual image plane.

FIG. 3 illustrates the optical path of a non-cross-cavity optical configuration, in accord with the invention.

FIGS. 4A and 4B are schematic representations of two methods of aligning the optical path to the eyes of different users; respectively, the two methods are translation of an integral neareye/folding optic holder and rotation of the near-eye optic about a central pivot.

FIGS. 5A and 5B are side views of glasses-mounted virtual display embodiments, in accord with the invention, in which the near-eye optic assembly is separate and distinct from the spectacle frame and positioned in front of the lens, and integrated into the spectacle frame, respectively.

FIG. 6 is a cross-sectional view of a virtual display apparatus constructed in accord with the invention.

FIG. 7 shows a perspective view of a head-mounted virtual display apparatus constructed in accordance with the invention.

FIG. 8 is a perspective view of an integral near-eye/folding optic assembly for the head-mounted virtual display apparatus in FIG. 7, which is disposed for translational motion.

### DETAILED DESCRIPTION OF THE DRAWINGS

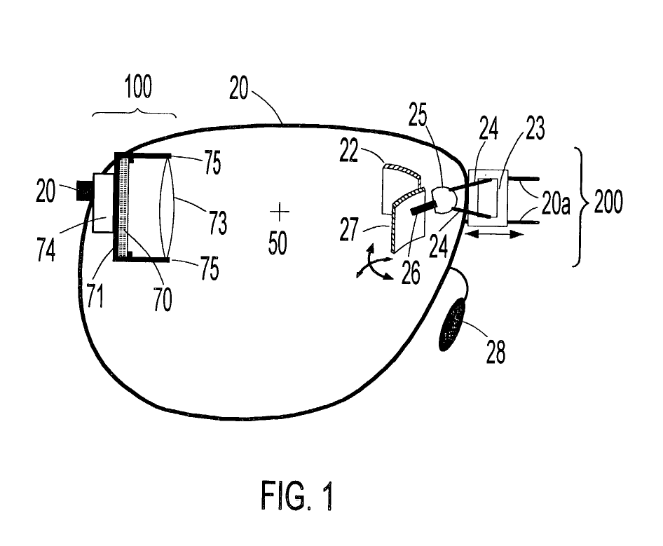

FIG. 1 is a schematic of a glasses-mounted virtual display based on a CCOC as disclosed by Geist in U.S. patent application Ser. No. 09/849,872. The eye (50) forms a horizontally plane with the general centers of the display (70) and the near-eye (22) and folding (27) optics.

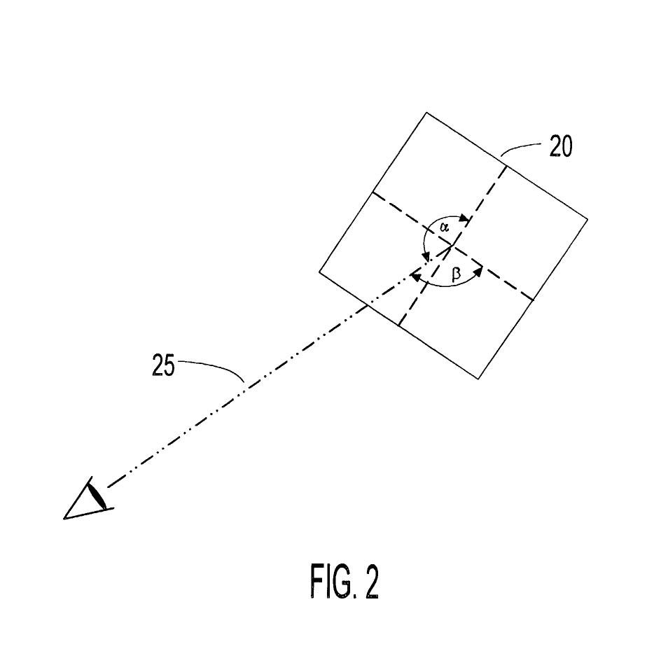

In FIG. 2, the angular orientation of the virtual image plane (20)—with respect to the optical axis (25) originating at eye—is represented by β and α.

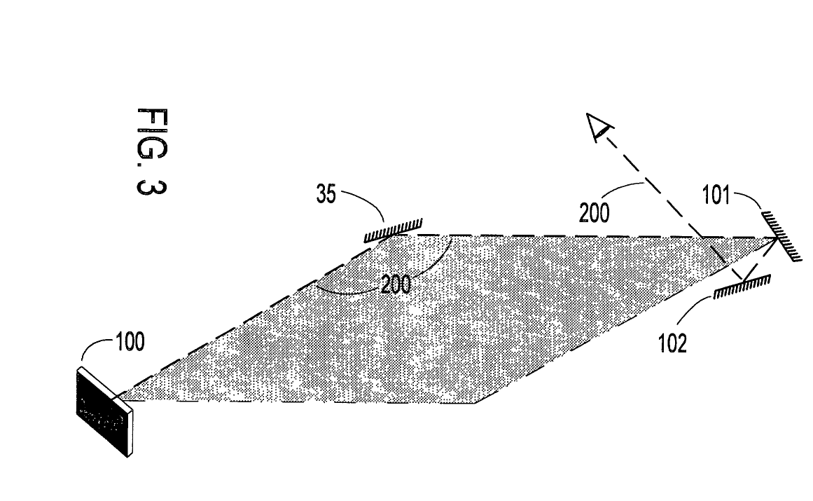

FIG. 3 illustrates the optical path (200) of a non-CCOC in accord with the invention. The optical path, originating at a miniature display (100), is redirected, in turn, by an additional light deflection means (35), an adjacent folding optic (101) and the near-eye optic (102) to, in effect, turn the optical pathway through two right angles and an upwards rotation.

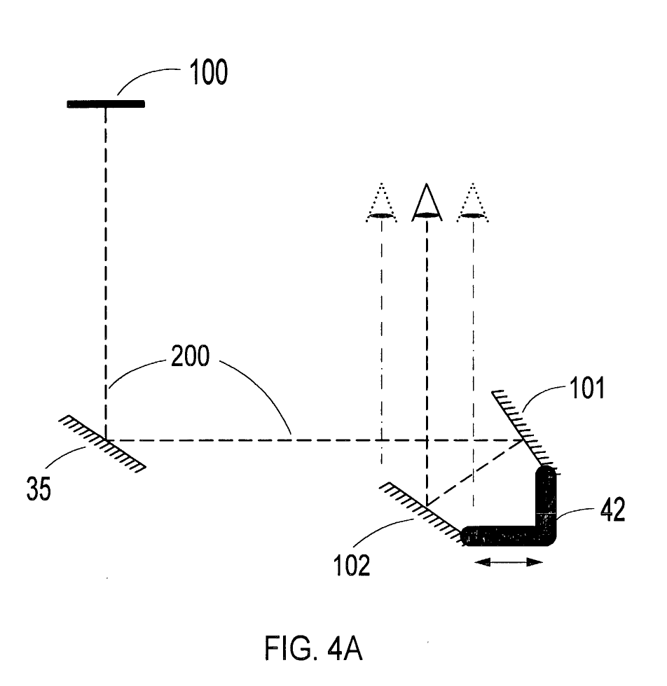

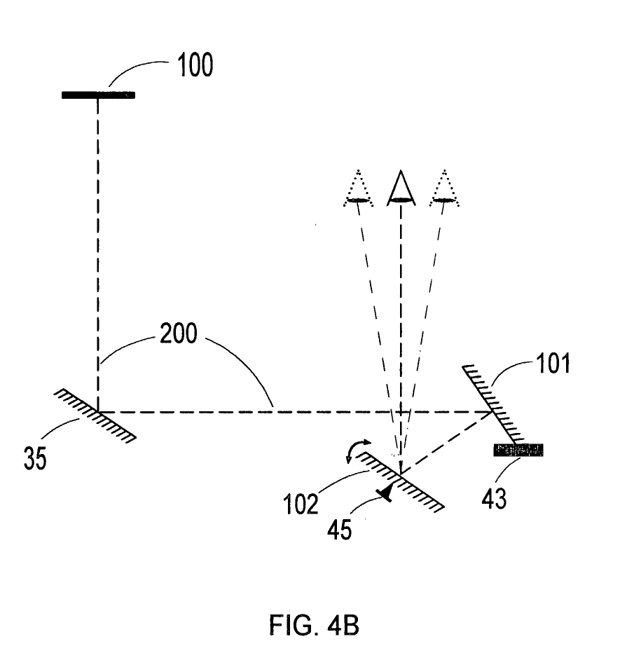

FIG. 4A illustrates one method of aligning the optical path (200) to eyes of users with different interpupillary distances (i.e., one method of providing a first adjustment means for a multi-user embodiment of the invention), when the near-eye optic assembly is located below eye level. This method involves simultaneous translation of the folding (101) and near-eye (102) optics, via an integral near-eye/folding optic holder (42). FIG. 4B illustrates a method of providing a first adjustment means that involves rotation of the near-eye optic (102) about a central pivot (45). The folding optic is affixed to a stationary holder (43). Alternatively, the both the near-eye and folding optics may be independently or simultaneously rotatable; and the respective pivot points may be placed at any desirable and practical locations.

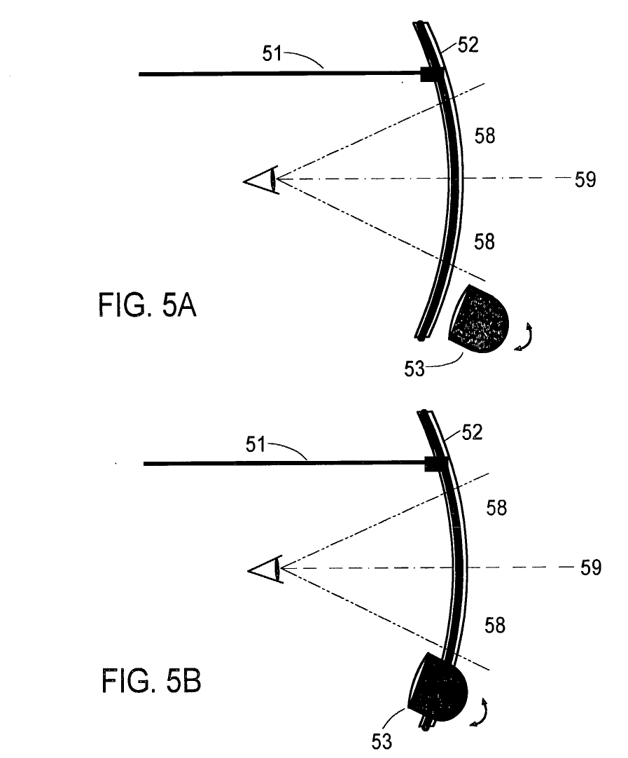

FIG. 5A is a side view of a glasses-mounted virtual display embodiment in accord with the invention in which near-eye optic assembly (53) and support means (not shown) is separate and distinct from the spectacle frame (51)—as in the case of a detachably connected virtual display apparatus in accord with the invention—and in which the near-eye optic positioned in front of the spectacle lens (52). FIG. 5B is a side view of a glasses-mounted virtual display embodiment in which the virtual display apparatus, including the near-eye optic assembly (53), is integrated into the spectacle frame (51).

Unobstructed forward vision (58) is qualitatively represented by the region between the dotted lines extending outwards from the eye in FIGS. 5A and 5B. Unobstructed forward vision (or the unobstructed forward FOV) is defined with respect to the forward line-of-sight (59). For the purposes of this invention, unobstructed forward vision is defined as the volume surrounding the forward line-of-sight (LOS) carved out by a circular cone with its vertex at the center of the pupil and a subtending angle of 17.5 degrees (between the forward LOS and the surface of the cone). This corresponds to an unobstructed forward FOV of 35 degrees or the equivalent of a 17.5 inch visual work area two feet from the eye. For conventional eyewear with an eye relief of 16 mm, the circular cross-sectional area of the “cone of unobstructed forward vision” at the lens is approximately 10 mm in diameter. Exclusion of the entire near-eye optic (and its underlying support structure) from the cone of unobstructed forward vision—corresponding to unobstructed and unobscured forward vision—is a common feature of each embodiment of the present invention.

Normal forward vision (or normal forward FOV) is defined for the purposes of this invention as the volume surrounding the forward LOS carved out by a circular cone with its vertex at the center of the pupil and a subtending angle of 40 degrees (between the forward LOS and the surface of the cone). Normal forward vision is divided into two parts: the unobstructed forward FOV and the normal peripheral FOV (or normal peripheral vision), which is the hollowed-out conical region with inside and outside subtending angles of 17.5 and 40 degrees, respectively. The visual region outside the “cone of normal forward vision” is termed the extended peripheral FOV. The near-eye optic may be located anywhere within the normal or extended peripheral fields of view, provided the location is readily accessible to the eye.

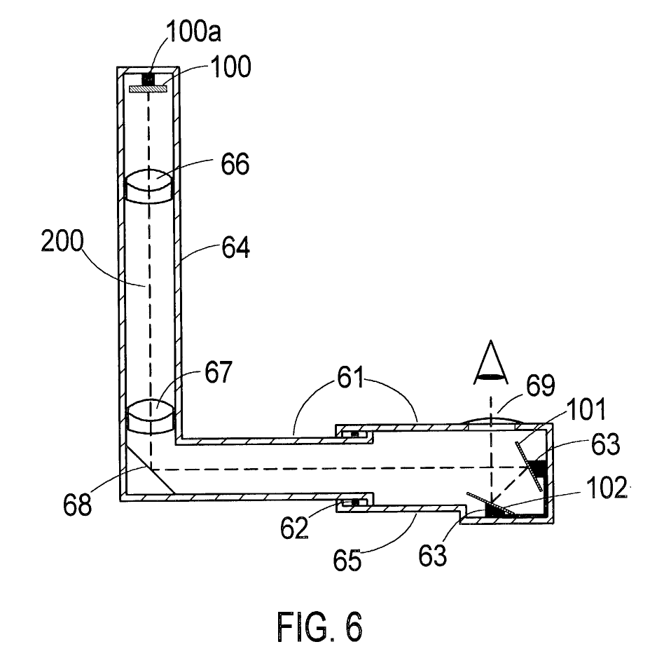

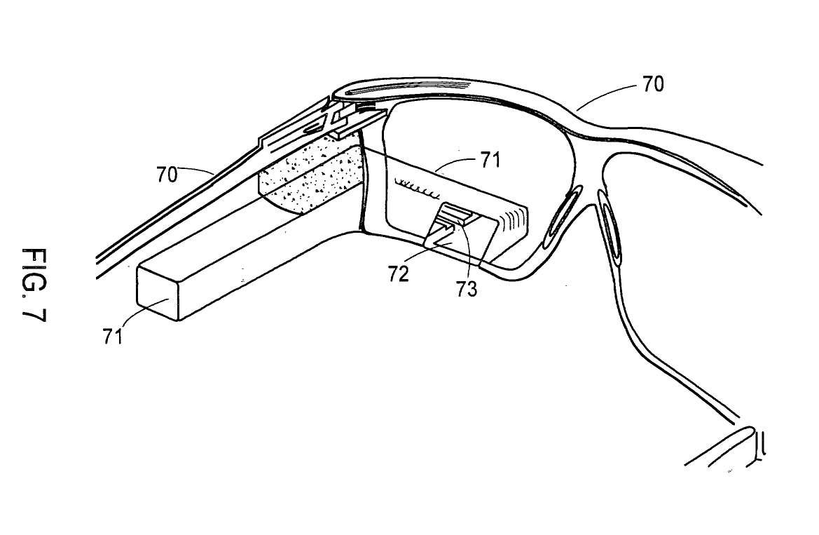

FIG. 6 is a cross-sectional view of a virtual display apparatus constructed according to the invention and suitable for temporary attachment or integration into a head-borne frame, in which the near-eye optic is located below eye level. The light path originating at the display approaches the near-eye optic from the side rather than from above as would be the case for a CCOC with the near-eye optic in the same location. The optical train consists of a microdisplay (100), a magnifying stage (66), an additional light deflection means (68), a near-eye optic (102), an adjacent folding optic (101), and two additional refractive elements (67 and 69). A refractive element (69) is positioned between the near-eye optic and the eye to minimizing the eye relief of the system and hence minimize the diameter of the optical train, as noted by Metzler and Moffitt in “Head Mounted Displays: Designing for the User”, incorporated in its entirety by reference herein. The adjustment means is a single moveable connection (with two degrees of freedom of motion) integrated into a two-piece support means (61). More specifically, the moveable connection is comprised of pair of telescoping, smooth-walled cylinders. This two-piece articulating support means allows simultaneous translation and rotation of the near-eye and folding optics (thus providing a first and second adjustment means). Centering of the light path on the eye involves translation of the integral near-eye/folding optic holder (63) to establish β=90° for each user. Rotation of the integral near-eye/folding optic holder (63) allows each user to establish a preferred value of α. The moveable piece (65) of the telescoping support means also serves as an integral near-eye/folding optic support bracket. The holders and support brackets for the other optical train elements are not shown for simplicity with the exception of the image source holder (100a). The smooth outer surface of the stationary support means component (64) and the outer surface of a rubber O-ring (62) provide the contact tracks of a linear translation stick-friction sliding mechanism (SFSM). The O-ring provides additional frictional resistance to prevent unintended movement between the telescoping cylinders during user activity. The O-ring (62) is positioned between the cylinders and is seated in a circumferential groove (not shown) in the outer wall of the stationary cylinder. The runner means is provided by the inner walls of the moveable cylinder (65).

Note that for this particular construct of the invention (or any construct where the relative angle between the near-eye optic and adjacent folding optic is fixed), the separate near-eye and adjacent folding optic may be replaced by a prism with two light deflecting surfaces (i.e., by a Penta prism), provided the area of the folding optic is large enough to prevent cropping of the image during alignment of the near-eye optic with the eye via rotation.

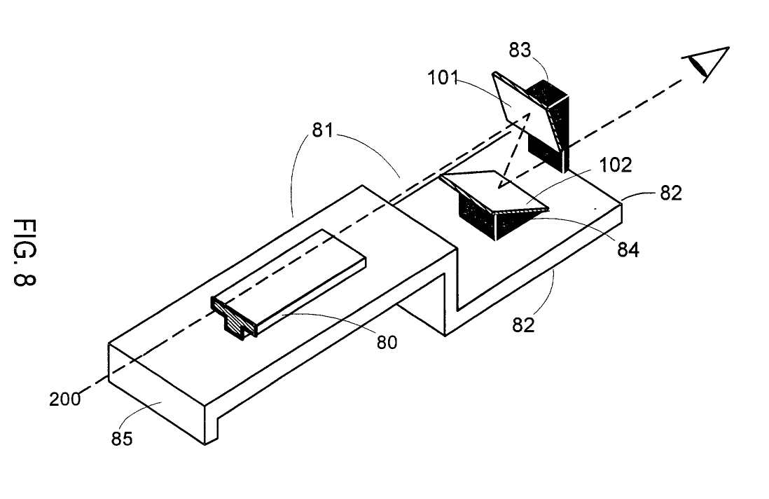

FIG. 7 is a perspective view of a virtual display apparatus constructed in accord with the invention and integrated into a pair of safety goggles (70). An L-shaped support means and integral housing (71) is positioned below eye level. A viewing window (72) is located in the normal reading glass location. The adjustment means is a moveable connection with a single degree of freedom of (translational) motion. The contact tracks (73) of the adjustment means are integral with the support means. The runners (80) of the adjustment means are integrated into an integral near-eye/folding optic assembly (FIG. 8). The runners moveably engage and slide across and along the contact tracks (73)—evident within the viewing window. The smooth mated surfaces of the contact tracks and runners form a SFSM, actuated by the user, for establishing one dimensional orthogonality.

FIG. 8 shows a perspective view of the integral near-eye and folding optic assembly (81) for the head-mounted virtual display apparatus of FIG. 7. In this embodiment of the invention, both the near-eye (102) and folding (101) optics are immoveable. Individual near-eye optic (83) and folding optic (84) holders are seated atop an integral near-eye/folding optic support bracket (82). The near-eye optic is generally centered on the eye by pushing or pulling handle (85).

Additional features of the invention may be noted from the embodiment represented in FIGS. 7 and 8. Firstly, for a non-CCOC with a single adjacent folding optic, the near-eye optic must be tilted with respect to the spectacle plane and, if two-dimensional orthogonality is to be satisfied, the near-eye optic must always rotatable. It follows, that for a non-CCOC with two adjacent folding optics, the near-eye optic may be parallel to the spectacle plane and may be fixed in place. It is further noted that the near-eye optic and a single folding optic are generally tilted towards one another (forming a nominal V configuration) and that the tilted pair of optics must be carefully oriented to prevent the folding optic from physically blocking the line of sight to the near-eye optic.

### DESCRIPTION OF THE PREFERRED EMBODIMENT

The preferred embodiment of the present invention is a GMD, based on a pair of safety glasses, for providing access to electronic information in a mobile workplace environment, be it in the field (e.g., by an insurance claims adjuster) or on the factory floor (e.g., by a technician maintaining an assembly line operation). Moreover, the preferred embodiment is a multi-user embodiment that provides to different users a complete, uncropped virtual representation of the image source.

The support means is a structural member with suitable means for mounting the image source, folding optic, and near-eye optic assemblies. The support means may be of unitary construction, may be composed of more than one attached and connected elements or pieces, or may be composed of a plurality of attached and connected pieces, provided the various components of the optical train remained optically aligned during mobile activities. In addition to structurally supporting the various assemblies comprising the invention, the support means may include standard mounting means for separably and detachably mounting the virtual display apparatus to a separate head-mounted support/apparatus. Moreover, the support means may be integrated or incorporated into a head-mounted support or head-borne frame. The preferred support means is integrated into a head-mounted support. More specifically, the preferred support means is integrated into a spectacle type frame of molded plastic construction, which uses both ears and the bridge of the nose for support, weight bearing and stabilization during user activity (i.e., is a frame with the same support structure as conventional eyewear). The support means may be constructed from plastic, metal, a polymer or other appropriate material or combination of materials. The support means may include standard mounting means for separably and detachably mounting the virtual display apparatus to a separate head-mounted support or apparatus.

Suitable head-mounted supports for mobile activities include, but are not limited to or conventional eyewear frames, goggles held in place with a strap or headband, and a headset style head-mounted support in contact with the ear and side of the head, in addition to the bridge of the nose.

To provide vision correction, magnification, an internal optical pathway and/or protective shielding, a transparency means—comprising zero, one, two, three, four or a plurality of transparencies—may be attached and connected to a head-mounted support with an integral or detachable virtual display apparatus in accord with the invention. As used herein, a transparency is defined as a relatively thin optical element (such that parallax error is minimal) of a highly transmissive and transparent nature that covers a region of the face. The transparency means may cover one or both eyes, one eye and other facial areas, both eyes and other facial areas (such as a protective visor or face-shield), portions of one or both eyes and/or other facial areas, or only facial areas. Part or all of a transparency may provide optical power, as in the cases of reading glasses and prescription lenses; or a transparency may be completely unpowered, as in the case of a protective shield. In addition, a refractive optical element may be integrated into and embedded within a transparency to provide magnification of a selected portion of the normal forward field of view. For example, a refractive element may be embedded in a transparency below eye level, in a fashion analogous to the bifocal area of a spectacle lens; or refractive elements for vision correction may be integrated into a face-shield. Furthermore, transparencies may overlap one another, as in the case when a face-shield covers the eyes, nose and mouth and prescription lenses (attached to the head-mounted support) lie behind the face-shield. In the case of conventional eyewear, the transparency means typically comprises separate transparencies (or lenses) covering each eye, which may have optical power for vision correction. An HMD or headset with zero transparencies is referred to as a lensless headset for the purposes of this invention. The transparency means may be constructed from plastic, glass, a polymer or other appropriate (outwardly) transparent material or combination of materials. The transparency means may be integrally formed with a head-mounted support and/or elements of one or more assemblies of the virtual display apparatus (VDA) using standard manufacturing methods, such as molding, casting, machining or laser cutting. The preferred transparency means is a pair of plastic lenses integrally formed with a lens holder by molding.

The optical pathway of an embodiment of the invention may be partially or completely internally disposed within any optically transparent structural components of the VDA (i.e., the support mean, holders, support brackets, etc.), within an integral or detachable head-mounted support, and/or within a transparency means. More typically the optical pathway of an embodiment of the invention is entirely external of the structural components of the VDA (and an associated head-mounted support or transparency means), corresponding to free-space optics embodiment. For example, for a headset with a face-shield, the optical pathway may pass through the face-shield (via internal reflection) to a near-eye optic located in the normal peripheral FOV The preferred embodiment is a free-space optics embodiment, in which the optical pathway is entirely external of the integral support means, head-mounted support and transparency means.

The real image source (or illumination source) is typically, but not exclusively, a miniature electronic display module, which displays alphanumeric text, graphical elements and/or video. The real image source may be selected from a monochrome alphanumeric display with just a few lines of text (the equivalent of a simple pager display), a monochrome or color alphanumeric/graphics display with multiple lines (the equivalent of a PDA or cellular telephone type display), a monochrome or color VGA/SVGA microdisplay (the equivalent of a computer monitor) or other appropriate illumination source. Other suitable illumination and visible light sources include visual lasers and light emitting diodes. The preferred illumination source is a color SVGA microdisplay.

A focusing means adjustably and controllably brings the virtual image plane within the near/far point range of each user and changes the apparent image distance from the eye allows image placement. The preferred focusing means provides adjustable and controllable translational motion of the magnifying stage coincident with and along the optical axis passing through the magnifying stage. Alternatively, image focusing and placement may be achieved by changing the relative position of any optical element with power, by increasing or decreasing the optical path length by changing the relative position of an appropriate element without optical power (e.g., moving the display closer to the magnifying stage); or by a simultaneous and appropriate combination of relative distance changes involving two or more powered or unpowered optical train elements (which result in a change in the effective focal length of the optical system). An adjustable and controllable focusing means, according to the invention, may be comprised of two or more separate and distinct elements attached, connected and in close proximity to one another. A focusing means includes at least one element selected to provide (at least two continuous) contact tracks and at least one element physically engaged with (and maintaining at least three contact points with at least two of) said contract tracts and selected to provide runner means (or runners), whose surface configuration is mated or matched to the surface configuration of the contact tracks. In general, the runner means move relative to the stationary contact tracks to provide a translational motion (or translation) mechanism. The mated surfaces of the contact track and runners may be smooth, toothed, threaded-groove or any other appropriate meshing or mated surface configuration disposed for translational motion of the runners relative to the contact tracks. In addition, the contact tracks may be shaped to generate a linear or curvilinear locus/path of motion.

The means of actuating the focusing means may be mechanical, electrical or electromechanical in nature. In addition, for a magnifying stage comprised of one or more lenslet arrays or stack of lenslet arrays, the type of micro-actuation means (i.e., electrostatic, magnetic, piezoelectric, bimetallic, etc.) used in micro-electromechanical systems may be employed. When the magnifying stage is comprised of bulk optical elements, the preferred actuation means is a so-called stick-friction sliding mechanism (SFSM). A SFSM is a translational motion mechanism (TMM) in which static-friction between the runners and contact tracks prevents relative motion unless sufficient force is applied to the runners to overcome the static friction. The focusing means of the preferred embodiment is incorporated into the image source assembly and employees an electrostatic micro-actuation mechanism for adjustably and controllably translating a stack of lenslet arrays.

When the near-eye optic is located in the normal peripheral FOV, redirection of the optical path towards the eye for establishment of virtual image plane orthogonality (i.e., establishment of either one- or two-dimensional orthogonality) necessitates one or more moveable connections (i.e., adjustment means) disposed for translational and/or rotational motion of the near-eye optic and/or any adjacent folding optics. For example, satisfying two-dimensional orthogonality (or one-dimensional orthogonality with a variable) typically requires independent or simultaneous articulation of a pair of adjacent LDEs, to accommodate the eye positions of different users.

In the absence of an adjacent folding optic, orthogonal alignment of the virtual image plane with the user's LOS is accomplished through the use of a single moveable connection (referred to herein as the near-eye optic adjustment means) to position and orient the near-eye optic at the same relative angular orientation for each user; in combination with either an optical train oriented to achieve 70°≦α≦110° for a normal range of eye positions without further adjustments (as disclosed by Geist in Ser. No. 60/311,929, incorporated herein by reference in part) or image warping electronics (to correct for geometric distortion of the image plane caused by tilting of the near-eye optic plane.

In the case of a single adjacent folding optic—as disclosed by Geist in Ser. No. 60/311,927, incorporated herein by reference in its entirety—two degrees of freedom of translation and/or rotation are required to establish two-dimensional orthogonality (or to allow both α and β to be varied), which may be achieved through the use of one or more moveable connections. In some embodiments of the invention, two moveable connections—corresponding to a first and second adjustment means—will be used to independently or simultaneously articulate and adjust the near-eye and folding optics. In general for this type of embodiment of the invention, a first adjustment means, corresponding to a first degree of freedom of motion, and a second adjustment means, corresponding to a second degree of freedom of motion, may each be selected from the group of:

(i) a moveable connection disposed for translation of the near-eye optic;

(ii) a moveable connection disposed for rotation of the near-eye optic;

(iii) a moveable connection disposed for translation of the folding optic;

(iv) a moveable connection disposed for rotation of the folding optic;

(v) a pair of moveable connections disposed for independent translation of the near-eye optic and the folding optic;

(vi) a pair of moveable connection disposed for independent rotation of the near-eye optic and the folding optic;

(vii) a moveable connection disposed for simultaneous translation of the near-eye optic and the folding optic;

(viii) a moveable connection disposed for simultaneous rotation of the near-eye optic and the folding optic;

(ix) a pair of moveable connections disposed for independent translation of the near-eye optic and rotation of the folding optic;

(x) a pair of moveable connections disposed for independent rotation of the near-eye optic and translation of the folding optic.

For example, a pair of moveable connections may be used to establish two-dimensional orthogonality by simultaneous movement of both the near-eye and folding optics (for a first degree of freedom of motion) and independent articulation of either the near-eye optic or the folding optic (for a second degree of freedom of motion).

In the case of a pair of adjacent folding optics (i.e., first and second adjacent folding optics)—as disclosed by Geist in Ser. No. 60/311,926, incorporated herein by reference in its entirety—two degrees to freedom of translation and/or rotation of the folding optics is required to establish two-dimensional orthogonality (or allow both α and β to be varied), which may be achieved through the use of one or more moveable connections. In some embodiments of the invention, two moveable connections—corresponding to a first and second adjustment means—will be used to independently or simultaneously articulate and adjust the two adjacent folding optics. In general for this type of embodiment of the invention, a first adjustment means, corresponding to a first degree of freedom of motion, and a second adjustment means, corresponding to a second degree of freedom of motion, may each be selected from the group of:

(i) a moveable connection disposed for translation of the first folding optic;

(ii) a moveable connection disposed for rotation of the first folding optic;

(iii) a moveable connection disposed for translation of the second folding optic;

(iv) a moveable connection disposed for rotation of the second folding optic;

(v) a pair of moveable connection s disposed for independent translation of the first and second folding optics;

(vi) a pair of moveable connections disposed for independent rotation of the first and second folding optics;

(vii) a moveable connection disposed for simultaneous translation of the first and second folding optics;

(viii) a moveable connection disposed for simultaneous rotation of the first and second folding optics;

(ix) a pair of moveable connections disposed for independent translation of the first folding optic and rotation of the second folding optic;

(x) a pair of moveable connections disposed for independent rotation of the first folding optic and translation of the second folding optic.

For example, a pair of moveable connections may be used to establish two-dimensional orthogonality by simultaneous movement of both adjacent folding optics (for a first degree of freedom of motion) and independent articulation of one of the two adjacent folding optics (for a second degree of freedom of motion).

In summary, for embodiments of the invention with at least one adjacent folding optic, the establishment of β=90° will typically involve articulation (i.e., translational and/or rotational movement) of at least one light deflecting optic, or simultaneous or independent articulation of a pair of light deflecting optics. Similarly, the establishment of α=90° will typically involve articulation of at least one light deflecting optic, or simultaneous or independent articulation of a pair of light deflecting optics (where the same light deflecting optic doe not undergo the same type of motion in establishing α and β; e.g., the adjustment means can not consist of two degrees of freedom of rotation of only the near-eye optic for orthogonality establishment owing to geometric distortions inherent in this optical configuration, which varies from user to user).

Note that in some embodiments of the invention, α=90° and β=90° cannot be established independently. In other words, both degrees of freedom of motion must be employed to establish either one- or two-dimensional orthogonality.

It is generally preferred that the number of moveable connections be kept to a minimum. (As such, the preferred adjustment means is a single moveable connection providing simultaneous rotation and translation of the near-eye and folding optics). In addition, the moveable connections comprising the adjustment means are often, but not exclusively, incorporated into an attachment and connection of the near-eye and/or folding optic assemblies. For example, in FIG. 6, an embodiment is shown in which a single moveable connection, with two degrees of freedom of motion, is integrated into the support means.

It is further noted that translation or rotation of the entire optical train may substitute, respectively, for simultaneous translation or rotation of the pair of LDEs (i.e., the near-eye optic and an adjacent folding optic or a pair of adjacent folding optics) used for adjustment of image plane orientation.

Each rotating moveable connection (or pivoting adjustment mechanism, PAM) is comprised of two or more separate and distinct elements integral with, attached to, connected to, and in close proximity to the support means, a head-mounted support, the transparency means of a head-mounted support, one or more elements of the image source, near-eye optic, folding optic, magnifying stage and/or additional optics assemblies, or a combination of these components anywhere in the proximity of the head. An PAM forming part of the adjustment means includes at least one element selected to provide (at least two continuous) contact tracks and at least one element physically engaged with the contact tracks and selected to provide runner means, whose surface configuration is mated or matched to the surface configuration of the contact tracks; wherein the runner means is selected to provide engagement and maintenance of at least three contact points with at least two of said contact tracks. In general, the runner means move relative to stationary contact tracks. The mated surfaces of the contact tracks and runners may be smooth, toothed, threaded-groove or any other appropriate meshing or mated surface configuration disposed for rotational motion of the runners relative to the contact tracks. In addition, the contact tracks may be shaped to generate a single curvilinear path of motion. Suitable PAMs include a simple hinge, a multiple-degree of freedom of rotation hinge (e.g., a ball joint) or any other appropriate mechanism providing rotational or pivoting motion.

Each translational motion mechanism (TMM) forming part of the adjustment means is comprised of two or more separate and distinct elements integral with, attached to, connected to, and in close proximity the support means, a head-mounted support, the transparency means of a head-mounted support, one or more elements of the image source, near-eye optic, folding optic, magnifing stage and/or additional optics assemblies, or a combination of these components anywhere in the proximity of the head. A TMM forming part of the adjustment means includes at least one element selected to provide (at least two continuous) contact tracks and at least one element physically engaged with the contact tracks and selected to provide runner means, whose surface configuration is mated or matched to the surface configuration of the contact tracks; wherein the runner means is selected to provide engagement and maintenance of at least three contact points with at least two of said contact tracks. In general, the runner means move relative to stationary contact tracks. The mated surfaces of the contact tracks and runners may be smooth, toothed, threaded-groove or any other appropriate meshing or mated surface configuration disposed for translational motion of the runners relative to the contact tracks. In addition, the contact tracks may be shaped to generate a linear or curvilinear path of motion. An example of a suitable TMM is a linear translation mechanism with mated smooth surfaces, such as the SFSM in the embodiment represented by FIGS. 7 and 8.

PAMs and TMMs providing adjustment means may be integrated into, attached to, connected to and in close proximity to the support means, a head-mounted support, the transparency means of a head-mounted support, one or more elements of the near-eye and/or folding optic assemblies, or a combination of these components anywhere in the proximity of the head. For example, the contact tracks of a TMM for centering the near-eye optic on the user's eye may be integrated into an integral support means and head-mounted support (as illustrated in FIG. 7).

In some embodiments of the invention, one or more elongated or extended LDEs may be used as a passive means of adjustment (or passive adjustment means) to decrease the number of moving parts (i.e., to decrease the number of moveable connections and/or the number of required degrees of freedom of motion). As used herein, an extended LDE is defined as an LDE (such as the near-eye or adjacent folding optics) whose surface area is greater than the minimum area required to fully redirect the incident illumination. An extended LDE thus allows the location of the incident illumination redirected by an LDE to vary from one user to another without cropping or cutting off a portion of the virtual representation of the image source. For example, use of an extended LDE can eliminate the need to simultaneously rotate both an adjacent folding optic and the near-eye optic in some embodiments of the invention (as may be required if the size of the LDEs is always kept to a minimum). In general, the degree of LDE elongation required for a given construction is that necessary to always capture an uncropped, resolute observable virtual image over the entire range of motion of the adjustment means. Passive adjustment means may also involve the use of standard beam steering techniques, such as the use of decentered lenses, provided due regard is given to the additional image degrading factors arising.

The mechanism actuating the adjustment means (i.e., the actuation means) may be of a mechanical, electrical and/or electromechanical nature. For example, the actuation means for the SFSM/moveable connection in FIG. 6 is mechanical energy input from the user. Alternatively, an electric motor may be used to drive/actuate a moveable connection.

A multi-user embodiment of the invention, based on one-dimensional orthogonality (with α not variable) may also be constructed in accord with the invention. A multi-user embodiment of this type will often be preferable, since the number of adjustments needed is reduced by one. In addition, an embodiment of this invention may be constructed with no adjustments or moveable connections, in accord with the invention, if it is designed for custom fitting to a single individual.

The preferred adjustment means is a single moveable connection—the form of a stick-friction sliding mechanism with smooth mated surfaces—integrated into a two-piece support means (as in the embodiment illustrated in FIG. 6), which provides simultaneous translation and rotation of the near-eye and folding optics. More specifically, the preferred moveable connection is comprised of pair of telescoping, smooth-walled cylinders. Additional frictional resistance against unintended movement of the telescoping cylinders is provided by a rubber O-ring positioned between the cylinders and seated in a circumferential groove in the outer wall of the inner cylinder. The outer wall of the inner cylinder and the outer surface of the O-ring provide the contact tracks of the SFSM; while the inner walls of the outer cylinder in contact with the O-ring (and any protrusions from the outer cylinder in contact with the outer wall of the inner cylinder) provide the runner means.

The focusing and adjustment means are typically incorporated into the attachments and connections of different assemblies or different attachment and connections of the same assembly. Construction considerations, however, (particularly in the case of integral assemblies, like an integral folding optic/near-eye optic assembly) may necessitate the incorporation of the focusing and adjustment means into the same attachment and connection.

The near-eye optic (or near-eye LDE) provides a light deflection means and is disposed for simultaneous illumination reception from the magnifying stage (or an adjacent folding optic) for observable virtual image formation and illumination redirection to the eye. The near-eye optic may also provide supplemental magnification of the real image source (and/or aberration reduction, polarization, or other standard optical means of visible light manipulation) and is positioned in the normal or extended peripheral FOV to provide unobstructed forward vision. For example, a partially reflective near-eye optic may be used to superimpose an observable virtual image on the surroundings (in the fashion of a see-through virtual display apparatus); a curved or flat, fully reflective first-surface mirror may be used to totally occlude a small portion of the normal peripheral FOV; or a portion of a spherical spectacle lens may be mirrored (in an embodiment employing two adjacent folding optics). The preferred near-eye optic is a flat, fully reflective first-surface mirror, consisting of a plastic substrate with vapor deposited aluminum and transparent protective coatings.

A near-eye optic assembly comprising a support bracket, holder and near-eye optic may be mounted to, integrated into, attached to and/or connected to the support means, a head-mounted support, the transparency means of a head-mounted support, one or more elements of the image source, folding optic, magnifying stage and/or additional optics assemblies, or a combination of these components anywhere in the proximity of the head. The near-eye optic assembly may be located anywhere in the normal peripheral FOV. For example, it may be located at eye level adjacent to the bridge of the nose, below eye level or above eye level. In addition, the near-eye optic may be placed in front or behind a lens or transparency. The preferred location of the near-eye optic assembly is below eye level and generally centered on the eye (i.e., corresponding to an interpupillary distance of between 50 and 74 mm). The support bracket and holder of the near-eye optic assembly may be comprised of any number of separate and distinct elements attached, connected and in close proximity to one another and may be formed together in an integral fashion. In addition, the support bracket or an integral support bracket and holder may be integrally formed with the support means, a head-mounted support, the transparency means of a head-mounted support, one or more elements of the image source, folding optic, magnifying stage and/or additional optics assemblies, or a combination of these components using standard manufacturing methods.

A focusing means may be partially or fully incorporated into (i.e., integrated into, attached to, connected to and in close proximity to) the near-eye optic assembly. The focusing means may be incorporated into the attachment and connection between the near-eye optic support bracket and the support means. Alternatively, the focusing means may be incorporated into the attachment and connection between the support bracket and the near-eye optic holder or the holder and the near-eye optic. In addition, the (first and/or second) adjustment means may be partially or fully incorporated into the near-eye optic assembly. Adjustment means may be incorporated into the attachment and connection between the holder and the near-eye optic, which is the generally preferred location. Construction considerations, however, may necessitate incorporating the adjustment means into the attachment and connection between the support bracket and the holder or between the support bracket and the support means. In the preferred embodiment no focusing means or adjustment means is incorporated into the near-eye optic assembly.

Temporary detachment and separation of the near-eye optic assembly from the support means or of individual elements of the assembly (for parts replacement or upgrading) may be achieved by incorporating standard (and construction appropriate) mounting means of tightly but detachably securing individual components and elements together (i.e., standard mounting means of removably mounting, fastening, connecting, gripping and clamping components in place to prevent movement between them), such a male-female connector, a snap-together type fastener or a spring-tensioned clamp. More specifically, the attachment and connections between the support means and the near-eye optic support bracket, the support bracket and the near-eye optic holder and the holder and the near-eye optic may be of a detachable and separable nature to allow temporary detachment and separation of the near-eye optic or the entire assembly.

Articulating means may be used to move the near-eye optic (and any underlying support elements) outside the normal peripheral field of view when the virtual display apparatus is not in use. More specifically, an articulating means, selected to provide at least one degree of freedom of movement, may be used to move the near-eye optic from its operational position in the normal peripheral FOV to the extended peripheral FOV, to provide unobstructed normal peripheral vision when the virtual display apparatus is not in use. Articulating means may be incorporated into the attachment and connection between the near-eye optic and its holder, which is the generally preferred location. Construction considerations, however, may necessitate incorporating the articulating means into the attachment and connection between the near-eye optic support bracket and holder or between the support means and the near-eye optic support bracket. For example, in the case of an integral transparency and near-eye optic assembly covering most of the face (i.e., a face-shield), an articulating means between the head-mounted support and the transparency allows the face-shield to be raised from its operational position when either the display apparatus is not in use or the protective function of the face-shield is not needed. A suitable articulating means has at least one degree of freedom of translation or rotation and may be simultaneously detachable. The preferred embodiment does not include an articulating means.

An image or illumination source assembly, comprising a real image source, a support bracket, image source and magnifying stage holders, and a magnifying stage, may be mounted to, integrated into, attached to and/or connected to the support means, a head-mounted support, the transparency means of a head-mounted support, one or more elements of the near-eye optic, folding optic, magnifying stage and/or additional optics assemblies, or a combination of these components anywhere in the proximity of the head. The image source assembly is typically located in the extended peripheral FOV, but may be located in the normal peripheral FOV. The preferred location of the image source assembly is below eye level near the user's cheekbone. The support bracket and holders of the image source assembly may each be comprised of any number of separate and distinct elements attached, connected, and in close proximity. In addition, the magnifying stage holder and image source holder may be integrally formed. Moreover, the image source holder or an integral magnifying stage/image source holder may be integrally formed with the support bracket. Furthermore, the support bracket or an integral support bracket and holder may be integrally formed with the support means, a head-mounted support, the transparency means of a head-mounted support, one or more elements of the near-eye optic, folding optic, magnifying stage and/or additional optics assemblies, or a combination of these components using standard manufacturing methods.

A focusing means may be incorporated (in part or in full) into the image source assembly. The focusing means may be incorporated into the attachment and connection between magnifying stage holder and the magnifying stage, which is the generally preferred location. Construction considerations, however, may necessitate incorporating the focusing means into the attachment and connection between the image source support bracket and image source holder, the image source and magnifying stage holders, or the support bracket and the support means. In the preferred embodiment, a focusing means is incorporated into the attachment and connection between the magnifying stage and the magnifying stage holder.

Temporary detachment and separation of the image source assembly from the support means or of individual elements of the assembly (for parts replacement or upgrading) may be achieved by incorporating construction appropriate and standard mounting means of tightly but detachably securing parts together. More specifically, the attachment and connections between the support means and the image source support bracket, the support bracket and the image source holder and/or the magnifying stage holder, the image source holder and the real image source, the image source and magnifying stage holders, and the magnifying stage holder and magnifying stage may be of a detachable and separable nature to allow temporary detachment and separation of the assembly, the magnifying stage and/or the real image source.

The magnifying stage may be held by or incorporated into an assembly separate and distinct from—but in close proximity to and of similar basic construct to—the image source assembly. A separate magnifying stage assembly is integral with, attached to, connected to and in close proximity to the support means.

The magnifying stage provides primary magnification of the real image source and is comprised of at least one bulk optical element, one or more lenslet arrays, or a stack of lenslet arrays. A suitable magnifying stage comprised of one or more bulk optical elements includes, but is not limited to, a simple magnifier, a multi-surfaced magnifier, or a compound magnification system comprised of refractive, reflective, diffractive, gradient index and/or holographic optical elements, surfaces and/or gratings, intermediate surfaces, optical coating, etc. The description of lenslet array systems by Burger in U.S. Pat. No. 6,124,974 (titled “Lenslet Array Systems and Methods”) is incorporated in its entirety by reference herein. Briefly, a lenslet (or microlens) array refers to a two-dimensional array (micro-) lenslets, comprised of refractive or non-refractive microlenslets. Typically there is one-to-one correspondence between the pixels of the real image source and the microlenslets of the lenslet array. A “stack” of lenslets arrays generally refers to a plurality of lenslet arrays (arranged substantially adjacent to one another) forming an array of lenslet channels. The preferred magnifying stage is a lenslet array stack providing magnification, aberration correction and collimation.

The means of actuating the magnifying stage for focus control and image placement may be of a mechanical, electrical or electromechanical nature. In addition, the actuation means for displacement of a magnifying stage comprised of one or more lenslet arrays or a lenslet array stack include the various type of micro-actuation means used in micro-electromechanical systems.

As described herein, projection of the light path to the eye when the near-eye optic is located in the normal peripheral FOV results in geometric distortion of the virtual image, plane due to tilting of the near-eye optic plane. In accordance with the invention, geometric distortion may be reduced or eliminated through the use of additional light deflection means (or folding optics) adjacent to the near-eye optic or, the absence of an adjacent folding optic, through the use of image warping chip technology. More specifically, the present invention include embodiments with a single folding optic adjacent to a moveable near-eye optic and embodiments with a pair of folding optics adjacent to an immoveable near-eye optic.

A folding optic provides a light deflection means and is disposed for simultaneous illumination reception from the magnifying stage or an adjacent folding optic for (second or third) intermediate image formation (in the most basic construct of the invention) and illumination redirection to the near-eye optic or an adjacent folding optic. In addition, a folding optic may provide supplemental magnification, aberration reduction, polarization and/or other standard optical means for visible light manipulation, such as setting the apparent image distance, providing compound magnification, minimize aberrations, folding the optical pathway, etc. Moreover, all adjacent folding optics are positioning in the normal or extended peripheral FOV. (Note, in general, any intermediate image—whether formed by the magnifying stage, a folding optic or additional optics—may be virtual or image.)

A folding optic assembly comprising a support bracket, holder, and at least one folding optic may be mounted to, integrated into, attached to and/or connected to the support means, a head-mounted support, the transparency means of a head-mounted support, one or more elements of the near-eye optic, image source, magnifying stage, and/or additional optics assemblies, or a combination of these components anywhere in the proximity of the head. The holder and support bracket of the folding optic assembly may be comprised of any number of separate and distinct elements attached, connected and in close proximity to one another, and may be integrally formed. In addition, the support bracket or an integral folding optic support bracket and holder may be integrally formed with the support means, a head-mounted support, the transparency means of a head-mounted support, one or more elements of the near-eye optic, image source, magnifying stage and/or additional optics assemblies, or a combination of these components using standard manufacturing methods.

A focusing means may be partially or fully incorporated into the folding optic assembly. The focusing means may be incorporated into the attachment and connection between the folding optic support bracket and the support means, which is the generally preferred location. Construction considerations, however, may necessitate incorporating the focusing means into the attachment and connection between the folding optic support bracket and holder or between the folding optic and its holder. In addition, a (first and/or second) adjustment means may be partially or fully incorporated into the folding optic assembly. The adjustment means may be incorporated into the attachment and connection between the folding optic and its holder, which is the generally preferred location. Construction considerations, however, may necessitate incorporating the adjustment means into the attachment and connection between the folding optic support bracket and holder or between the folding optic support bracket and the support means.

Temporary detachment and separation of the folding optic assembly from the support means or of individual elements of the assembly (for parts replacement or upgrading) may be achieved by incorporating construction appropriate and standard means of tightly but detachably securing parts together. More specifically, the attachment and connections between the support means and the folding optic support bracket, the folding optic support bracket and holder, or between the folding optic and its holder and may be of a detachable and separable nature to allow temporary detachment and separation of the assembly or the folding optic.

The preferred folding optic assembly is located below eye level, adjacent to the near-eye optic assembly and is integrally formed with the near-eye optic assembly. The preferred folding optic is a flat, first-surface mirror. No focusing or adjustment means is incorporated into the folding optic assembly in the preferred embodiment.

Additional optical means—such as aspheric refractive elements, fold LDEs (to increase the optical path length or further fold the optical train); filters; optical coatings; beamsplitters; intermediate image surfaces; diffractive, gradient index, polarizing and holographic optical elements, surfaces and gratings; microlens arrays, etc.—may be added to a construct of the present invention anywhere along the optical pathway between the real image source and the eye to achieve standard optical means of visible light manipulation. (This includes placing refractive elements between the near-eye optic and the eye.) For example, a diffractive optical element may be added to an optical train containing a number of plastic elements to correct for color aberrations, or an intermediate image surface—such as a screen or Fresnel lens—may be added to balance aberrations and other unwanted artifacts. Additional optical means may be comprised of a single additional optical element (AOE), more than one AOE or a plurality of AOEs. Additional optical means (also referred to herein as additional optics) may be incorporated into or detachably and separably mounted to the image source, folding optic, magnifing stage and/or near-eye optic assemblies using appropriate mounting means of mounting and/or attachment and connection. In addition, AOEs may be added to the virtual display apparatus via separate “additional optics” assemblies, which may support and hold one or more AOE.

An additional optics assembly comprising a support bracket, holder and additional optics may be mounted to, integrated into, attached to and/or connected to the support means, a head-mounted support, the transparency means of a head-mounted support, one or more elements of the near-eye optic, image source, magnifying stage, and/or folding optic assemblies, or a combination of these components anywhere in the proximity of the head. Moreover, the support bracket and holder of an additional optics assembly may be comprised of any number of separate and distinct elements attached, connected and in close proximity to one another, and may be integrally formed. Furthermore, the additional optics support bracket or an integral support bracket and holder may be integrally formed with the support means, a head-mounted support, the transparency means of a head-mounted support, one or more elements of the image source, magnifying stage, near-eye optic and/or folding optic assemblies, or a combination of these components using standard manufacturing methods.

A focusing means may be partially or fully incorporated into an additional optics assembly. The focusing means may be incorporated into the attachment and connection between the additional optics support bracket and the support means, which is the generally preferred location. Construction considerations, however, may necessitate incorporating the focusing means into the attachment and connection between the additional optics support bracket and holder or between an AOE and its holder.

Temporary detachment and separation of the additional optics assembly from the support means or of individual elements of the assembly (for parts replacement or upgrading) may be achieved by incorporating construction appropriate and standard means of tightly but detachably securing parts together. More specifically, the attachment and connections between the additional optics support bracket and holder, the support bracket and the support means, and the holder(s) and the AOE(s) may be of a detachable and separable nature to allow temporary detachment and separation of the assembly or the additional optics. In the preferred embodiment, a bulk, convex refractive element is place between the near-eye optic and the eye to minimize the eye relief of the device.

The optical path length of a virtual display apparatus in accord with the invention may be increased through the use fiber optics, such as a bundle of coherent optical fibers or a flexible light pipe, or a graded index lens conduit. The pathway of such light conduits may be curvilinear or linear. For example, an optical fiber bundle (or cable) may carry light from the real image source to the magnifying stage when the magnifying stage is not located immediately adjacent to the image source assembly, but rather is attached and connected to the support means via a separate and distinct assembly a short distance from the image source.

It is advantageous in embodiments of the invention that include a head-mounted support to include an adjustable (nose) bridge support to ensure that the support means is not skewed relative to the user's face. The preferred adjustable bridge support provides a means for tilting the head-mounted support from side-to-side so that the user can adjust the head-mounted support to their facial structure. The adjustable bridge support may take the form a pair of malleable bridge support arms, bendable metal-flange type nose pads that can be pinched together, a ball-and-socket connection or other suitable means of “squaring-off” or aligning the head-mounted support to the user's face (as occurs during “fitting” of prescription eyewear). (An adjustment may be incorporated into a detachable VDA in accord with the invention to perform the analogous function.) An adjustable bridge support may also be used to change the vertical distance between the head-mounted support and the bridge of the nose.

An embodiment of the invention may include one or more optical trains. Each optical train may be distinct and independent or may share common segments. For example, a biocular virtual display apparatus may be constructed using a single display by splitting the optical pathway into two distinct paths after the pathway exits the image source assembly, with the two paths leading to a pair of near-eye optics (generally centered on the eyes either above or below eye level). Or, a binocular virtual display apparatus may be constructed using two completely separate and distinct optical trains with separately controllable image sources (i.e., a dual channel modality) being virtually projected by two near-eye optics, both positioned either above or below eye level and generally centered on the eyes. Alternatively, a dual monocular display apparatus may be created by incorporating separate optical trains into the left and right hand sides of the apparatus and placing the two near-eye optics at different locations (not simultaneously observable), such as below eye level, centered on the eye for the left eye and above eye level, near the temple of the right eye. Moreover, a multi-monocular display apparatus may be created by placing multiple near-eye optics at various peripheral locations, provided care is taken not to simultaneously display distinct virtual images. For example, as with a heads-up display, different information related to the task at hand (e.g., such as operation of a vehicle, monitoring body conditions during aerobic activity, or any general activity requiring “multi-tasking” or quick access to different sources of information) may be readily accessed while maintaining primary focus on the forward field of view. Thus with the same eye, the user may view different sources of information when looking in different directions. Separate image sources may be used for each near-eye optic or a single image source may provide images for more than one eyepiece. In the latter case, separate optical trains may lead to each near-eye optic or portions of each optical train may be made redundant to minimize the number of required optical elements.

All or a portion of the elements of a virtual display constructed apparatus according to the invention may be enclosed in housings, which may be mounted to, integrated into, attached to and/or connected to the support means, a head-mounted support, the transparency means of a head-mounted support, elements of one or more of the assemblies, or a combination of these components anywhere in the proximity of the head. Any and all housings may be of a detachable and removable nature to allow temporary separation.

The various assemblies of the invention may be constructed from plastic, metal, a polymer or other appropriate material or combination of materials. The preferred material is plastic.

As used herein, electrical and electronic means is comprised, but not limited to, an electrical power source (e.g., a battery or external power source), electrical circuitry, electronics, and a signal source (such as a data/video signal source or a computer output, preferably an SVGA output). The electrical circuitry should be capable of receiving video and computer output signals via electrical wiring, via fiber optical cabling, via infrared link, via a radio frequency link, or via any appropriate mode of wired or wireless signal transmission. Electrical wiring may pass through an attached conduit or may be attached, incorporated, integrated and/or embedded in the support means, a head-mounted support, the transparency means of a head-mounted support, elements of one or more assemblies, or a combination of these components anywhere in the proximity of the head. In addition, the electronics should be capable of scanning and synchronizing a video signal, and interfacing and displaying a computer output.

Lastly it is noted that, when taken together, the series of assemblies added to a support means, in combination with the attachments and connections that allow temporary separation and detachment of one or more assembly (including separation and detachment of the support means from a head-mounted support), provide modular construction capabilities. For example, a head-mounted support (with transparency means) may serve as the “chassis” for multiple embodiments of the invention, where each embodiment involves a different set of assemblies, different locations for the assemblies or a combination of both cases. More generally, a modular approach may be used to construct user-specific or custom-fit devices, where the same support means (with appropriate mounting means for attachment and connection of the various assemblies) may be mounted to or integrated into various types of conventional eyewear; with the optical train characteristics being based on the user's requirements, i.e., the combination of optical train elements provide both the desired degree of magnification, the desired apparent image distance and correction for the user's specific optical deficiency.

### DESCRIPTION OF ANOTHER EMBODIMENT

Another embodiment of the invention is a lensless virtual display headset based on a spectacle type frame with a QVGA microdisplay positioned next to the cheekbone of the wearer and a near-eye optic positioned below eye level. A tooth-geared, linear translation SFSM allows the near-eye optic to be positioned directly below the eye of each user and an image warping chip included in the electrical and electronic means is programmed to establish one dimensional orthogonality. An adjustable bridge support—in the form of a ball joint—allows the spectacle frame to be “squared-off” for each user's facial structure. In addition, flexible nose pads, consisting of thin metal extensions coated with a deformable and pliable polymer, may be pinched together or spread apart to allow the device to be securely and comfortably fit to different users. Flexible earpieces, consisting of a bendable, goose-neck type shaft coated with a pliable polymer, provide a further degree of adaptability for different users. The image source assembly is an integral unit housing an SVGA microdisplay (and associated electrical interconnects). An electrically controllable, toothed-gear SFSM allows translation of the magnifying stage, which consists of a stack of microlens arrays for focus control and image placement.

What is claimed is, briefly stated,

1. A virtual display apparatus based on a non-cross-cavity optical configuration comprising
a support means integral with, attached to, connected to and in close proximity to a near-eye optic assembly comprising
a near-eye optic integral with, attached to and connected to
a near-eye optic holder integral with, attached to and connected to
a near-eye optic support bracket integral with, attached to, connected to and in close proximity to said support means;
a near-eye optic adjustment means in close proximity to said near-eye optic; and
furthermore said support means is additionally integral with, attached to, connected to and in close proximity to
an image source assembly comprising
a real image source, in communication with electrical and electronic means, integral with, attached to and connected to
an image source holder integral with, attached to and connected to
an image source support bracket integral with, attached-to, connected to and in close proximity to said support means; and
a magnifying stage holder integral with, attached to and connected to said image source holder, and additionally integral with, attached to and connected to
a magnifying stage in close proximity to said real image source;
wherein said magnifying stage is disposed for simultaneous illumination reception from said real image source for first intermediate image formation and illumination transmission to said near-eye optic and is selected to provide primary magnification of said real image source;
wherein said near-eye optic provides a light deflection means, positioned in the normal peripheral field of view for unobstructed forward vision attainment and disposed for simultaneous illumination reception from said magnifying stage for observable virtual image formation and illumination redirection to the eye, and is additionally selected to provide supplemental magnification of said real image source;
wherein said near-eye optic adjustment means is disposed for preferred positioning, placement and orientation of said near-eye optic relative to the eye of each user;
wherein said electrical and electronic means includes image warping electronics for geometric distortion correction of the virtual image plane, caused by tilting of the near-eye optic plane relative to the optical axis, and, additionally, for orthogonal alignment of the virtual image plane with the viewer's line-of-sight and orthogonality establishment and achievement.

2. The virtual display apparatus of claim 1, wherein said magnifying stage is selected from the group consisting of at least one bulk optical element, one two-dimensional lenslet array, and a stack of two-dimensional lenslet arrays.

3. The virtual display apparatus of claim 1, wherein said near-eye optic adjustment means is selected from the group consisting of a moveable connection disposed for translation of said near-eye optic and a moveable connection disposed for rotation of said near-eye optic.

4. The virtual display apparatus of claim 1, wherein said support means is integral with, attached to, connected to and in close proximity to an additional optics assembly comprising
additional optics integral with, attached to and connected to
an additional optics holder integral with, attached to and connected to
an additional optics support bracket integral with, attached to, connected to and in close proximity to said support means;
wherein said additional optics are disposed for positioning and placement within the optical train between said real image source and the user's eye for simultaneous illumination reception and illumination transmission and redirection, and is additionally selected to provide supplemental magnification, aberration reduction, polarization and light deflection.

5. The virtual display apparatus of claim 1, wherein said support means is integral with, attached to, connected to and in close proximity to a focusing means selected for focused observable virtual image establishment and achievement at a desired apparent distance from the user's eye; and wherein said focusing means is integral with, attached to, connected to and in close proximity to said magnifying stage holder and is additionally selected to provide translational motion of said magnifying stage coincident with and along the optical train axis passing through said magnifying stage.

6. The virtual display apparatus of claim 5, wherein said focusing means comprises
at least two continuous focusing contact tracks integral with, attached to, connected to and in close proximity to said magnifying stage support bracket; and
focusing runner means selected for the engagement and maintenance of at least three contact points with at least two of said focusing contact tracks, said focusing runner means integral with, attached to, connected to and in close proximity to said support means; and wherein said focusing runner means is disposed for translational motion relative to said focusing contact tracks.

7. The virtual display apparatus of claim 1, wherein said near-eye optic assembly, said image source assembly, and said folding optic assemblies are separably and detachably connected to said support means using standard mounting means.

8. The virtual display apparatus of claim 1, wherein said support means is integral with, attached to, connected to and in close proximity to a head-mounted support.

9. The virtual display apparatus of claim 8, wherein the said support means is separably and detachably connected to said head-mounted support using standard mounting means.

10. The virtual display apparatus of claim 8, wherein said head-mounted support is in contact with the bridge of the user's nose and is integral with, attached to, connected to and in close proximity to a transparency means, said transparency means selected from the, group consisting of zero, one, two, three and four transparencies.

11. A virtual display apparatus based on a non-cross-cavity optical configuration comprising
a support means integral with, attached to, connected to and in close proximity to
a near-eye optic assembly comprising
a near-eye optic integral with, attached to and connected to
a near-eye optic holder integral with, attached to and connected to
a near-eye optic support bracket integral with, attached to, connected to and in close proximity to said support means; and
furthermore said support means is additionally integral with, attached to, connected to and in close proximity to
a folding optic assembly comprising
a folding optic integral with, attached to and connected to
a folding optic holder integral with, attached to and connected to
a folding optic support bracket integral with, attached to, connected to and in close proximity to said support means;
furthermore said support means is additionally integral with, attached to, connected to and in close proximity to
an image source assembly comprising
a real image source, in communication with electrical and electronic means, integral with, attached to and connected to
an image source holder integral with, attached to and connected to
an image source support bracket integral with, attached to, connected to and in close proximity to said support means; and
a magnifying stage holder integral with, attached to and connected to said image source holder, and additionally integral with, attached to and connected to
a magnifying stage in close proximity to said real image source;
furthermore said support means is additionally integral with, attached to, connected to and in close proximity to
a first adjustment means; and
a second adjustment means;
wherein said magnifying stage is disposed for simultaneous illumination reception from said real image source for first intermediate image formation and illumination transmission to said folding optic, and is additionally selected to provide primary magnification of said real image source;
wherein said folding optic provides a light deflection means and is disposed for simultaneous illumination reception from said magnifying stage for second intermediate image formation and illumination redirection to said near-eye optic;
wherein said near-eye optic provides a light deflection means, positioned in the normal peripheral field of view for unobstructed forward vision attainment and disposed for simultaneous illumination reception from said folding optic for observable virtual image formation and illumination redirection to the eye, and is additionally selected to provide supplemental magnification of said real image source;
wherein said first and second adjustment means are disposed for orthogonal alignment of the virtual image plane with the viewer's line-of-sight and orthogonality establishment and achievement.

12. The virtual display apparatus of claim 11, wherein the magnifying stage is selected from the group consisting of at least one bulk optical elements, one two-dimensional lenslet array, and a stack of two-dimensional lenslet arrays.

13. The virtual display apparatus of claim 11, wherein said electrical and electronic means includes image warping electronics for geometric distortion correction of the virtual image plane.

14. The virtual display apparatus of claim 11, wherein said support means is integral with, attached to, connected to and in close proximity to
an additional optics assembly comprising
additional optics integral with, attached to and connected to
an additional optics holder integral with, attached to and connected to
an additional optics support bracket integral with, attached to, connected to and in close proximity to said support means;
wherein said additional optics are disposed for positioning and placement within the optical train between said real image source and the user's eye for simultaneous illumination reception and illumination transmission and redirection, and is additionally selected to provide supplemental magnification, aberration reduction, polarization and light deflection.

15. The virtual display apparatus of claim 11, wherein said support means is integral with, attached to, connected to and in close proximity to a focusing means selected for focused observable virtual image establishment and achievement at a desired apparent distance from the user's eye; and wherein said focusing means is integral with, attached to, connected to and in close proximity to said magnifying stage holder and is selected to provide translational motion of said magnifying stage coincident with and along the optical train axis passing through said magnifying stage.

16. The virtual display apparatus of claim 11, wherein said focusing means comprises
at least two continuous focusing contact tracks integral with, attached to, connected to and in close proximity to said magnifying stage support bracket; and
focusing runner means selected for the engagement and maintenance of at least three contact points with at least two of said focusing contact tracks, said focusing runner means integral with, attached to, connected to and in close proximity to said support means; and
wherein said focusing runner means is disposed for translational motion relative to said focusing contact tracks.

17. The virtual display apparatus of claim 11, wherein said near-eye optic assembly, said image source assembly, and said folding optic assemblies are separably and detachably connected to said support means using standard mounting means.

18. The virtual display apparatus of claim 11, wherein said support means is integral with, attached to, connected to and in close proximity to a head-mounted support.

19. The virtual display apparatus of claim 18, wherein the said support means is separably and detachably connected to said head-mounted support using standard mounting means.

20. The virtual display apparatus of claim 11, wherein said head-mounted support is in contact with the bridge of the user's nose and is integral with, attached to, connected to and in close proximity to a transparency means, said transparency means selected from the group consisting of zero, one, two, three and four transparencies.

21. The virtual display apparatus of claim 11, wherein said first adjustment means and said second adjustment means are selected from the group of
a moveable connection disposed for translation of said near-eye optic,
a moveable connection disposed for rotation of said near-eye optic,
a moveable connection disposed for translation of said folding optic,
a moveable connection disposed for rotation of said folding optic,
a pair of moveable connections disposed for independent translation of said near-eye optic and said folding optic,
a pair of moveable connections disposed for independent rotation of said near-eye optic and said folding optic,
a moveable connection disposed for simultaneous translation of said near-eye optic and said folding optic,
a moveable connection disposed for simultaneous rotation of said near-eye optic and said folding optic,
a pair of moveable connections disposed for independent translation of said near-eye optic and rotation of said folding optic, and
a pair of moveable connections disposed for independent rotation of said near-eye optic and translation of said folding optic.

22. A virtual display apparatus based on a non-cross-cavity optical configuration comprising
a support means integral with, attached to, connected to and in close proximity to
a near-eye optic assembly comprising
a near-eye optic integral with, attached to and connected to
a near-eye optic holder integral with, attached to and connected to
a near-eye optic support bracket integral with, attached to, connected to and in close proximity to said support means; and
furthermore said support means is additionally integral with, attached to, connected to and in close proximity to
a folding optic assembly comprising
a first folding optic integral with, attached to and connected to
a first folding optic holder integral with, attached to and connected to
a first folding optic support bracket integral with, attached to, connected to and in close proximity to said support means;
a second folding optic integral with, attached to and connected to
a second folding optic holder integral with, attached to and connected to
a second folding optic support bracket integral with, attached to, connected to and in close proximity to said support means;
furthermore said support means is additionally integral with, attached to, connected to and in close proximity to
an image source assembly comprising
a real image source, in communication with electrical and electronic means, integral with, attached to and connected to
an image source holder integral with, attached to and connected to
an image source support bracket integral with, attached to, connected to and in close proximity to said support means; and
a magnifying stage holder integral with, attached to and connected to said image source holder, and additionally integral with, attached to and connected to
a magnifying stage in close proximity to said real image source;
furthermore said support means is additionally integral with, attached to, connected to and in close proximity to
a first adjustment means; and
a second adjustment means;
wherein said magnifying stage is disposed for simultaneous illumination reception from said real image source for first intermediate image formation and illumination transmission to said folding optic, and is additionally selected to provide primary magnification of said real image source;
wherein said first folding optic provides a light deflection means and is disposed for simultaneous illumination reception from said magnifying stage for second intermediate image formation and illumination redirection to said second folding optic;
wherein said second folding optic provides a light deflection means and is disposed for simultaneous illumination reception from said first folding optic for third intermediate image formation and illumination redirection to said near-eye optic and is additionally selected to provide further supplemental magnification of said real image source;
wherein said near-eye optic provides a light deflection means, positioned in the normal peripheral field of view for unobstructed forward vision attainment and disposed for simultaneous illumination reception from said second folding optic for observable virtual image formation and illumination redirection to the eye, and is additionally selected to provide supplemental magnification of said real image source;
wherein said first and second adjustment means are disposed for orthogonal alignment of the virtual image plane with the viewer's line-of-sight and orthogonality establishment and achievement.

23. The virtual display apparatus of claim 22, wherein the magnifying stage is selected from the group consisting of at least one bulk optical elements, one two-dimensional lenslet array, and a stack of two-dimensional lenslet arrays.

24. The virtual display apparatus of claim 22, wherein said electrical and electronic means includes image warping electronics for geometric distortion correction of the virtual image plane.

25. The virtual display apparatus of claim 22, wherein said support means is integral with, attached to, connected to and in close proximity to
an additional optics assembly comprising
additional optics integral with, attached to and connected to
an additional optics holder integral with, attached to and connected to
an additional optics support bracket integral with, attached to, connected to and in close proximity to said support means;
wherein said additional optics are disposed for positioning and placement within the optical train between said real image source and the user's eye for simultaneous illumination reception and illumination transmission and redirection, and is additionally selected to provide supplemental magnification, aberration reduction, polarization and light deflection.

26. The virtual display apparatus of claim 22, wherein said support means is integral with, attached to, connected to and in close proximity to a focusing means selected for focused observable virtual image establishment and achievement at a desired apparent distance from the user's eye; and wherein said focusing means is integral with, attached to, connected to and in close proximity to said magnifying stage holder and is selected to provide translational motion of said magnifying stage coincident with and along the optical train axis passing through said magnifying stage.

27. The virtual display apparatus of claim 22, wherein said focusing means comprises at least two continuous focusing contact tracks integral with, attached to, connected to and in close proximity to said magnifying stage support bracket; and
focusing runner means selected for the engagement and maintenance of at least three contact points with at least two of said focusing contact tracks, said focusing runner means integral with, attached to, connected to and in close proximity to said support means; and
wherein said focusing runner means is disposed for translational motion relative to said focusing contact tracks.

28. The virtual display apparatus of claim 22, wherein said near-eye optic assembly, said image source assembly, and said folding optic assemblies are separably and detachably connected to said support means using standard mounting means.

29. The virtual display apparatus of claim 22, wherein said support means is integral with, attached to, connected to and in close proximity to a head-mounted support.

30. The virtual display apparatus of claim 22, wherein the said support means is separably and detachably connected to said head-mounted support using standard mounting means.

31. The virtual display apparatus of claim 22, wherein said head-mounted support is in contact with the bridge of the user's nose and is integral with, attached to, connected to and in close proximity to a transparency means, said transparency means selected from the group consisting of zero, one, two, three and four transparencies.

32. The virtual display apparatus of claim 22, wherein said first adjustment means and said second adjustment means are selected from the group of
a moveable connection disposed for translation of said first folding optic,
a moveable connection disposed for rotation of said first folding optic,
a moveable connection disposed for translation of said second folding optic,
a moveable connection disposed for rotation of said second folding optic,
a pair of moveable connections disposed for independent translation of said first and second folding optics,
a pair of moveable connections disposed for independent rotation of said first and second folding optics,
a moveable connection disposed for simultaneous translation of said first and second folding optics,
a moveable connection disposed for simultaneous rotation of said first and second folding optics,
a pair of moveable connections disposed for independent translation of said first folding optic and rotation of said second folding optic, and
a pair of moveable connections disposed for independent rotation of said first folding optic and translation of said second folding optic.
